(19) United States
(12) Patent Application Publication
(10) Pub. No.: US 2025/0100440 A1
(43) Pub. Date: Mar. 27, 2025

(54) QUICK CONNECT CARGO SECURING SYSTEM

(71) Applicant: Truxedo, Inc., Ann Arbor, MI (US)

(72) Inventors: William Roy Cohoon, Brighton, MI (US); Nathan Jacob Kirschenman, Yankton, SD (US); Samuel Maurice Gusso, Yankton, SD (US)

(21) Appl. No.: 18/372,727

(22) Filed: Sep. 26, 2023

(51) Int. Cl. B60P 7/08

(52) U.S. Cl. CPC B60P 7/0815

(57) ABSTRACT

A cargo securing system for a vehicle having a cargo area that includes two securing rails, a first rail of which is attached to the first wall of the cargo area, and a second rail of which is attached to the second wall of the cargo area; two tie downs, a first tie down of which is attached to the first rail, and a second tie down of which is attached to the second rail; two support feet, a first support foot of which is attached to the first tie down, and a second support foot of which is attached to the second tie down; and a cross member configured to connect to the two support feet and extend across the cargo area; the first support foot has a latch to engage the first tie down to attach the first support foot to the first tie down.

### CROSS REFERENCE TO RELATED APPLICATIONS

None.

### FIELD

These teachings relate to a cargo securing system for a vehicle.

### BACKGROUND

Some vehicles, like pick-up trucks, have an open-topped bed or cargo area that may be used for storing or transporting cargo. A cover, such as a tonneau cover, may be placed over the cargo area. The tonneau cover may be moved into an open position to provide access to the cargo and/or the inside of the cargo area. The tonneau cover may be moved into a closed position to conceal the cargo from view and/or to prevent fluid and/or debris from entering the cargo area.

Some vehicles have a cargo securing system to help secure a load or cargo to the vehicle. For example, some vehicles may include one or more load tie downs in the cargo area of the vehicle. A rope, chain, or strap may engage the one or more tie downs to help secure the load or cargo to or in the cargo area. Other vehicles may include a rack or platform for transporting items such as ladders and kayaks.

However, many of the current cargo securing systems cannot be quickly or easily installed. For example, a user who wishes to at least temporarily utilize a rack or platform system may be required to fixedly mount the rack or platform system to the cargo area, which may be time and labor consuming. Then, when the user desires to remove the rack or platform system, the user must disassemble the system from the vehicle, which may also be time and labor consuming.

Accordingly, improvement in this field may be desired. For example, it may be desirable to have a cargo securing system that includes a rack or platform system that can be quickly and easily installed on the vehicle and/or then taken off the vehicle.

### SUMMARY

These teachings provide a cargo securing system for a vehicle. The cargo securing system includes a rack or platform system that can be quickly and easily installed on a vehicle. The cargo securing system includes a rack or platform system that can be quickly and easily removed or disassembled from a vehicle. The cargo securing system includes a rack or platform system that can be quickly and easily installed on the vehicle and/or removed from the vehicle without the use of hand tools.

The cargo securing system includes a rack or platform that can engage and disengage one or more load tie downs that are attached to the vehicle. The cargo securing system includes a rack or platform that can engage and/or disengage one or more load tie downs without the use of hand tools.

### BRIEF DESCRIPTION OF THE DRAWINGS

FIG. 1 is a perspective view of a vehicle that includes a tonneau cover and a plurality of load tie downs.

FIG. 2 is a perspective view of a vehicle that includes a tonneau cover and a plurality of load tie downs.

FIG. 3 is a perspective view of a securing rail and a load tie down of the cargo securing system.

FIG. 4 is a perspective view of a load tie down of the cargo securing system.

FIG. 5 is a perspective view of the cargo area of a vehicle and the load tide downs and the rack or platform system of the cargo securing system.

FIG. 6. is an exploded perspective view of the cargo securing system that includes a securing rail, a load tie down, a support foot, and a cross member.

FIG. 7A is a cross sectional view of a support foot engaging a load tie down.

FIG. 7B is a cross sectional view of a support foot and a load tie down.

FIG. 7C is a cross sectional view of a support foot and a load tie down.

FIG. 8 is a perspective view of a support foot and a cross member.

FIG. 9 is a cross sectional view of a cross member.

FIG. 10A is an exploded perspective view of a support foot.

FIG. 10B is an exploded perspective view of the mechanism inside of the support foot.

FIG. 10C is an exploded view of a portion of the mechanism inside of the support foot.

FIG. 11A is a perspective view of the mechanism inside of the support foot.

FIG. 11B is an exploded perspective view of the mechanism inside of the support foot.

FIG. 11C is an exploded view of a portion of the mechanism inside of the support foot.

### DETAILED DESCRIPTION

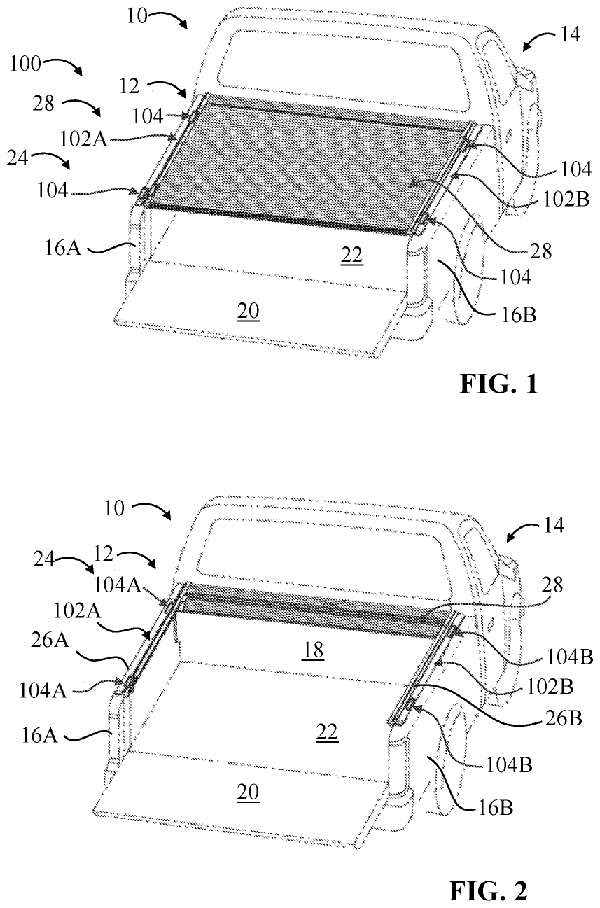

A vehicle 10 is illustrated in FIG. 1 and in FIG. 2. The vehicle 10 comprises a bed or cargo area 12 and a passenger area or cab 14. The illustrated vehicle 10 is a pickup truck. However, the vehicle 10 may be any other vehicle, such as a utility vehicle, boat, trailer, ATV, UTV, semi-truck, dump truck, camper, etc.

The cargo area 12 may be defined by one or a plurality of walls. The walls may include opposing side walls 16A, 16B (i.e., driver and passenger side walls respectively), a front wall 18 that is located adjacent to the passenger cab 14, and a rear wall or tailgate 20 that opposes the front wall 18. Two or more of these walls may be a single or integral wall. One or more of these walls may be split into two or more walls. For example, the tailgate, side wall, or front wall may be split into two or more walls to provide versatile access to the cargo area or passenger area of the vehicle.

The front wall 18 of the cargo area 12 may be a shared or common wall with a back wall of the passenger cab 14. Such vehicles may be a one piece or uni-body construction. In other vehicles, the front wall 18 may be a separate wall, segment, or portion of the vehicle from a rear wall of the passenger cab 14. In some configurations, the front wall 18 may provide access to the passenger cab 14 via a pass through or fold down wall or door. The cargo area 12 has a bottom or floor 22 that is surrounded by the walls 16A, 16B, 18, 20. The bottom or floor 22 is opposite a top or open end of the cargo area 12.

A tonneau cover system 24 may be positioned, located, installed, supported, or arranged on, onto, in, or over the bed or cargo area 12. The tonneau cover system 24 may include a rail system that is located or attached to the side walls 16A, 16B of the cargo area 12 (and/or on the front or back walls 18, 20); a tonneau cover 28 that is supported on or by the frame system or side rails. The cover 28 may be moveable relative to the side rails and side walls 16A, 16B between a closed position (FIG. 1) and an open position (FIG. 2). The cover 28 may be virtually any tonneau cover, for example, a cover with rigid panels (plastic, metal, extruded, printed), soft panels (tarp like). The cover can be a roll-up cover that is rolled and unrolled into the open and closed positions. The cover can be a fold or flip cover that has panels that are flipped or stacked on or under one another to move the cover between the closed and open positions.

A cargo securing system 100 may be operatively connected to the vehicle 100 or the cargo area 12.

The cargo securing system 100 may include one or more securing rails 102A, 102B. The securing rails 102A, 102B may be the same rails that are used to support the tonneau cover 28 of the tonneau cover system 24 discussed above. Alternatively, the securing rails 102A, 102B of the cargo securing system 100 may be separate and independent from any of the side rails of the tonneau cover system 24 for supporting the tonneau cover 28. The securing rails 102A, 102B may be attached to the corresponding side walls 16A, 16B. For example, a securing rail 102A, 102B may be attached to an upper surface of the side wall 16A, 16B where one or more stake holes may be located) and/or may be attached to the inside surfaces of one or more of the side walls 16A, 16B. The one or more securing rails 102A, 102B may be one or more bed caps that are attached to the top surfaces of the side walls 16A, 16B. The or more securing rails 102A, 102B may be attached to the one or more bed caps.

The one or more securing rails may be made from a suitable material such as aluminum, plastic, metal, a composite, or combination thereof. The one or more securing rails may be an extrusion, a plastic injection molded part, a stamped part, a 3D printed part, or a combination that out. The one or more securing rails may be made from one or more materials.

The cargo securing system 100 may include one or more load tie downs 104. One or more of the load tie downs 104, or tie downs 104 for short, may be operatively connected to one or both of the securing rails 102A, 102B. The tie downs 104 may be attached to the securing rails 102A, 102B such that the tie downs 104 do not interfere with operation of the tonneau cover system 24. In other words, attachment of the one or more tie downs 104 to one or both of the securing rails 102A, 102B does not interfere with or prohibit the moving of the tonneau cover 24 between the closed and open positions.

The one or more load tie downs may be made from a suitable material such as aluminum, plastic, metal, a composite, or combination thereof. The one or more load tie downs may be an extrusion, a plastic injection molded part, a stamped part, a 3D printed part, or a combination that out. The one or more load tie downs may be made from one or more materials. For example, the load tie down may be made entirely of a single material, or the load tied out may be made of two materials for example the handle may be made of metal and the body and operates may be made of a plastic or nylon material.

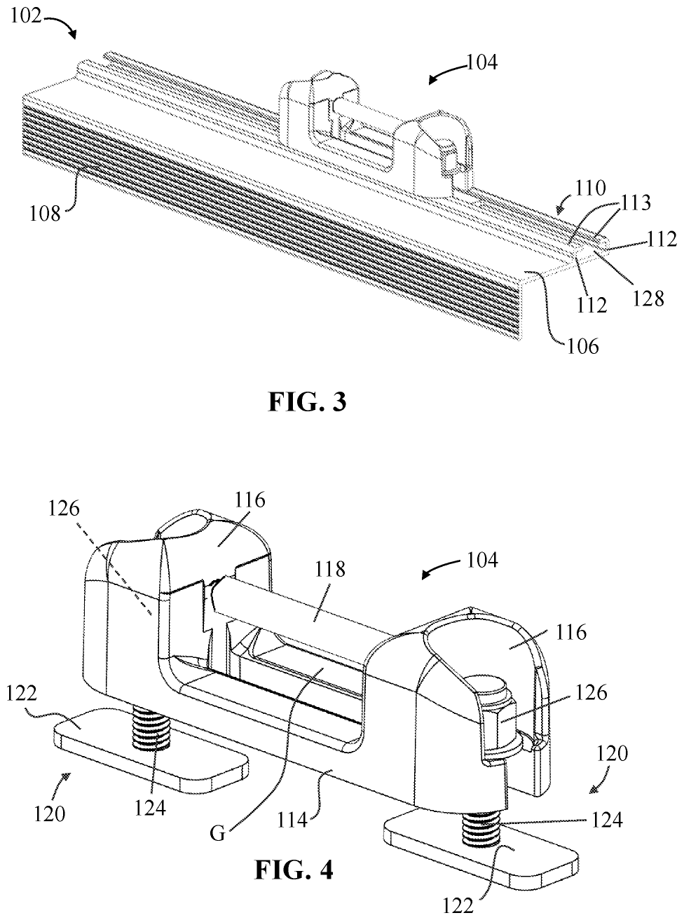

FIG. 3 illustrates a segment of the securing rail 102 of the cargo securing system and a tie down 104 of the cargo securing system operatively connected to the securing rail 102.

The securing rail 102 may include a generally horizontal portion 106 and a downwardly turned part or flange or vertical portion 108. In vehicle position, the generally horizontal portion 106 may be positioned on or attached to a top surface of a side wall of the cargo area. The generally vertical portion 108 may be engaged by one or more clamps to secure the securing rail 102 to the bed wall. The generally vertical portion 108 may include one or more ribs or grooves that extend along a length of the vertical portion. These ribs or grooves may be arranged horizontally and may assist with attaching the securing rail to the bed wall via the one or more clamps. In some configurations, one or both of the horizontal and the vertical portions 106, 108 may be secured to the bed wall via one or more fasteners such as screws, bolts, and/or adhesives. In some configurations, the vertical portion may be omitted and the securing rail 102 may be attached by other methods, such as with one or more fasteners extending from the back or B-side of the horizontal portion 106 that may engage the top surface of the side wall 16 of the cargo area. In some configurations, the horizontal portion 106 and/or the securing rail 102 may be attached to the bed cap which is typically located on the upper surface of the bed wall. In some configurations, the securing rail 102 may be the bed cap.

The horizontal portion 106 may include an engagement slot 110. The engagement slot 110 may extend at least partially or entirely along a length of the securing rail 102. In some configurations, the engagement slot 110 may be part of the bed cap. In some configurations, the engagement slot 110 may be directly attached to the top surface of the bed wall and or incorporated into the material of the bed wall itself.

The engagement slot 110 may have a generally C- or U-shaped cross section. The engagement slot 110 may be defined by a pair of opposing walls 112 that project upwardly from the horizontal portion 106. The engagement slot 110 may include a pair of opposing inwardly turned fingers 113 at an upper end of the opposing walls 112. The engagement slot 110 may be engaged by one or more tie downs 104.

With additional reference to FIG. 4, a load tie down 104 may be a cleat or other structure that includes a generally U-shaped base 114 having a pair of opposing upright portions 116, and a handle portion 118 extending between the two upright portions 116. The tie down 104 comprises a gap G defined between the handle 118 and the base 114. The gap G may allow a user to route a cable, strap, or cord around the handle 118 to secure the load or cargo to the tie down 104. The tie down 104 may include one or more securing parts 120 for securing the tie down 104 to the securing rail 102. Each securing part 120 may include a moveable securing plate 122, a threaded part 124, and a tightening part 126. The threaded 124 and tightening 126 parts may be a bolt and nut assembly, respectively.

To attach the tie down 104 to the securing rail 102, the securing plates 122 may be inserted into the engagement slot 110 of the securing rail 102 through an open end 128 of the slot 110. The tie down 104 can then be moved along a length of the securing rail 102 or slot 110 into any desired location along a length of the slot 110, between the passenger area or cab of the vehicle and the tailgate for example. After the tie down 104 is in its desired location, the tightening part 126 may then be tightened, which will close a gap defined between the moveable securing plate 122 and bottom of the base 114 thereby capturing or sandwiching the inwardly turned parts 113 of the opposing walls 112 of the slot 110 therebetween. Thereafter, the tie down 104 may be secured to the securing rail 102 and restricted from moving. An operator or user may tie or attach a rope, cord, cable, or strap to the handle part 118 to secure cargo in the bed or cargo area of the vehicle.

An operator may move or reposition the location of one or more of the tie downs 104 by simply loosening the tightening part 126 so that the gap defined between the bottom surface of the base 114 and the moveable securing plate 122 is enlarged thereby allowing the tie down 104 to be moved along a length of the slot 110 to a desired location. Then the tightening parts 126 may be re-tightened to capture the inwardly turned fingers 113 of the engagement slot 110 between the plate 122 and the bottom of the base 114.

The cargo securing system may include any number of tie downs 104 on one or both sides of the securing rails 102.

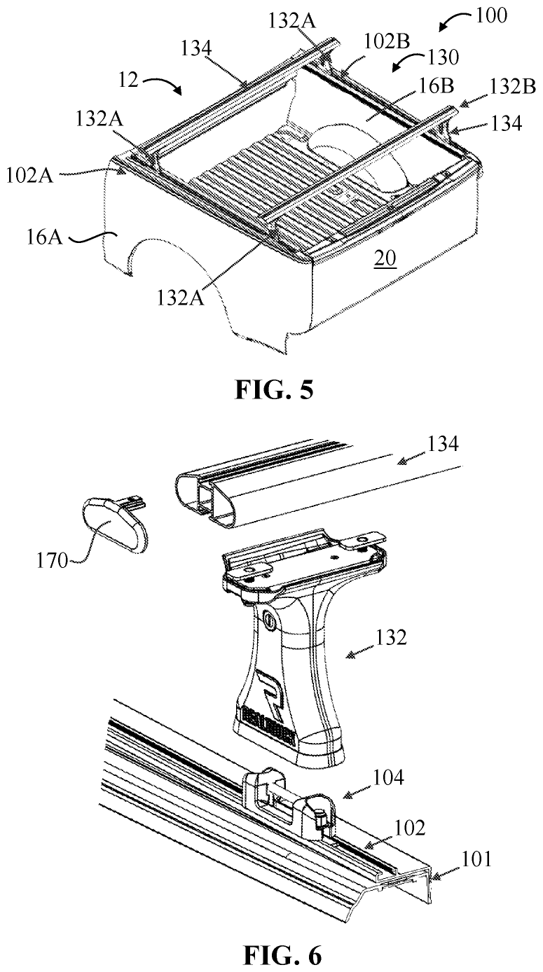

FIG. 5 illustrates the cargo area 12 of the vehicle. A cargo securing system 100 is connected to the cargo area 12.

With additional reference to FIG. 6, the cargo securing system 100 includes the securing rails 102 (102A, 102B) and the one or more tie downs 104 connected to one or both of the securing rails 102 (102A, 102B). The securing rail 102 may be attached to or incorporated into a bed cap 101 that is attached to a side wall of the cargo area. The bed cap 101 may cover a top surface of a side wall of the cargo area. The top surface of the side wall may be the surface or region where stake pocket holes are typically located. Alternatively, the securing rail 102 may be attached to one of the side walls of the cargo area. The cargo securing system 100 includes a rack or platform system 130. The rack or platform system 130 may be attached to the cargo area 12 of the vehicle. The rack or platform system may be configured to carry or support one or more items above the cargo area 12 and/or above any tonneau cover installed over the cargo area 12, whether the tonneau cover is in the closed or open positions (See FIGS. 1 and 2). The rack or platform system 130 according to these teachings is configured to not interfere with any operation of the tunnel cover (e.g., during moving the tunnel cover between the open and closed positions). The rack or platform system 130 may include one or more support feed 132 and one or more cross members 134. The cross member 134 may include an end cap 170 to close an open end of the cross member 134 as will be discussed further below.

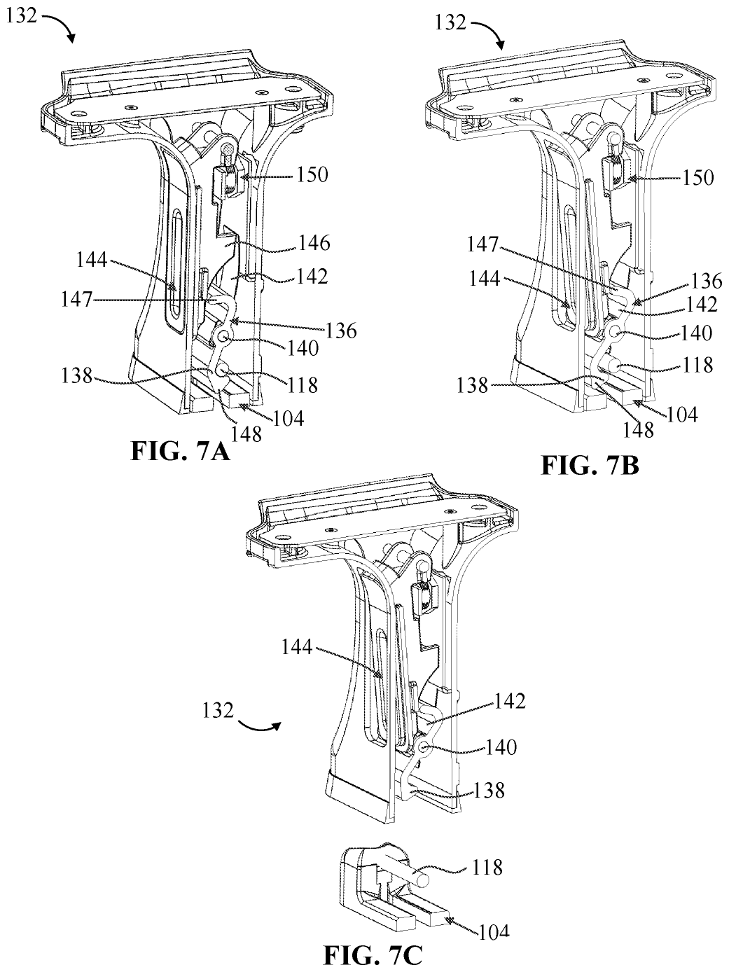

FIGS. 7A, 7B, and 7C illustrate a support foot 132 and a tie down 104 of the cargo securing system. The support foot 132 comprises a latch 136 that is configured to engage the tie down 104 to connect the support foot 132 to the tie down 104. More specifically the latch 136 comprises a finger 138. The finger 138 may have a generally Z- or S-shape. The finger 138 may have an upper part 147 and a lower part 148. The lower part 148 of the finger 138 is configured to engage the handle 118 of the tie down 104 to attach the support foot 132 to the tie down 104. The finger 138 is configured to be moved or rotated between a latched position (FIG. 7A) and an unlatched position (FIG. 7B, 7C). In the latched position, the support foot 132 is engaged with the tie down 104 such that the support foot 132 cannot be separated from the tie down 104. In the unlatched position (FIG. 7B, 7C), the support foot 132 can be moved or separated from the tie down 104.

The latch 136 comprises a pin or axle 140 about which the finger 138 is configured to be moved, pivoted, or rotated about to move the finger between the latched and unlatched positions The pin or axle may be made of a plastic or metal material.

The latch 136 comprises a spring or bias member 142. The spring or bias member 142 is configured to move and maintain the finger 138 (and a button 144) in a latched position when the latch 136 is in steady state. The spring or bias member may be a piece of spring metal, steel, plastic, a spring, a coil spring, a torsion spring, or a combination thereof.

The latch 136 comprises a button 144 that is configured to be moved or depressed by a user. The button 144 is moved into contact with the upper part 147 of the finger 138 to move the finger 138 and the spring or bias member 142 from the latched position (FIG. 7A) to the unlatched position (FIG. 7B, 7C). By pressing or moving the finger 138 into the unlatched position, the support foot 132 can be removed or separated from the tie down 104. The spring or bias member 142 is configured to move the finger 138 (and the button 144) back from the unlatched position (FIG. 7B, 7C) to the latched position (FIG. 7A) after the user releases the button 144. As best shown in FIG. 7A, the spring or bias member 142 engages the finger 138 around the pin or axle 140 and also a rib 146 of the button 144 to function as described above

As has been discussed, the steady state position of the finger 138 is in the latched position (FIG. 7A) regardless if the finger 138 is engaged around the handle 118 of the tie down 104.

During installation of a support foot 132 onto a tie down 104, a user may vertically lower the support foot 132 onto the tie down 104. The support foot 132 can be lowered on to the tie down 104 until a leading end or surface 148 of the finger 138 contacts the handle 118 of the tie down 104, which will cause the finger 138 to move, roll, or rotate about the axle 140 into the unlatched position. This movement of the finger 138 into the unlatched position will allow the support foot 132 to be further lowered onto the tie down 104. After the support foot 132 is in its lowered position, the user may release the button 144, which will cause the spring or bias 142 member to move the finger 138 (and the button 144) into the latched position such that the finger 138 will at least partially surround the handle 118 of the tie down 104 thereby preventing any vertical movement of the support foot 132 relative to the tie down 104.

Thereafter, should a user desire to remove the support foot 132 from the tie down 104, the user may depress the button 144 which will cause the finger 138 to rotate about the axle 140 to disengage the finger 138 from the handle 118. This will allow the support foot 132 to be vertically removed and separated from the tie down 104.

The support foot 132 include a lock 150. The lock 150 may include a tumbler or latch that can be rotated by a key to lock the button 144 and/or the finger 138 to prevent the finger 138 from rotating into the unlatched position. This will allow a user to securely lock the support foot 132 onto the tie down 104 and prevent any unintended removal or separation therefrom.

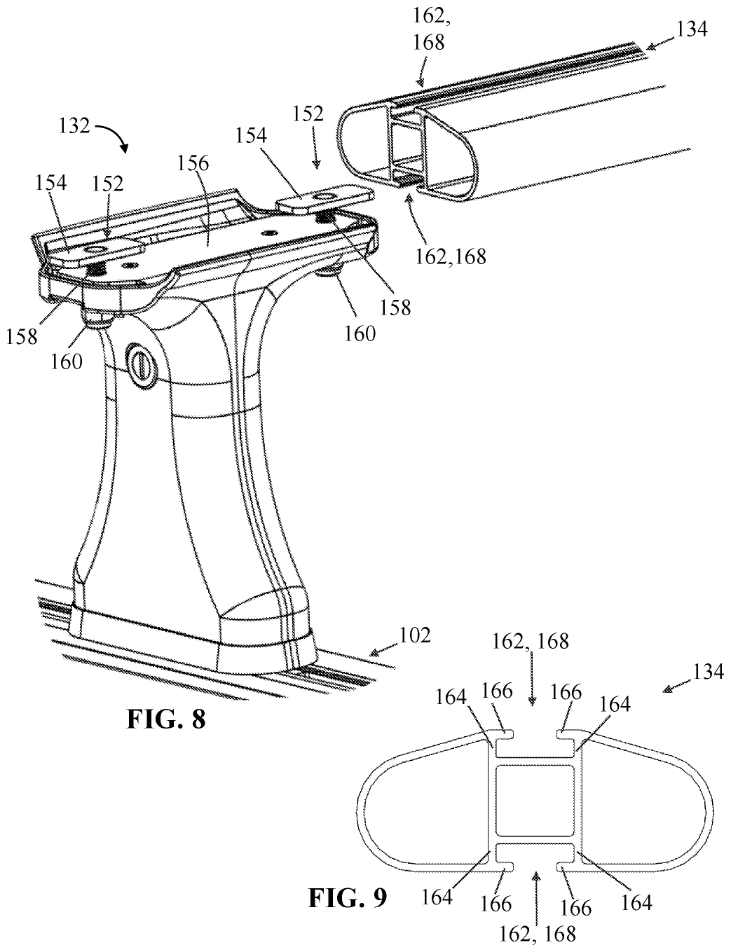

FIG. 8 illustrates a support foot 132 and a cross member 134. The support foot 132 comprises one or more securing parts 152 for securing the support foot 132 and the cross member 134. Each securing part 152 may include a moveable securing plate 154, a stationary securing plate 156, a threaded part 158, and a tightening part 160. The threaded 158 and tightening 160 parts may be a bolt and nut assembly, respectively.

The cross member 134 may include an engagement slot 162. With additional reference to FIG. 9, the engagement slot 162 may have a generally C- or U-shaped cross section. The engagement slot 162 may be defined by a pair of opposing walls 164 and a pair of opposing inwardly turned fingers 166 at an end of the opposing walls 164.

The cross member 134 may include only one engagement slot 162. Alternatively as illustrated in the figures, the cross member 134 may include two engagement slots 162. This may allow for the cross member 134 to be attached to a support foot 132 in one or even two configurations (i.e., attaching a top side of the cross member 134 to the support foot 132 or rotating the support member and attaching a bottom side of the cross member 134 to the support foot 132). Additionally or alternatively, having two engagement slots 162 may allow for the cross member to be used to attach other components to a top side of the cross member during use (e.g., a tie down according to these teachings).

The one or more cross members may be made from a suitable material such as aluminum, plastic, metal, a composite, or combination thereof. The one or more cross members may be an extrusion, a plastic injection molded part, a stamped part, a 3D printed part, or a combination that out. The one or more cross members may be made from one or more materials.

To attach a cross member 134 to a support foot 132, the securing plates 154 may be inserted into the engagement slot 162 of the cross member 134 through an open end 168 of the slot 162. The cross member 134 can then be moved laterally until both of the plates 154 engage the slot 162. After the cross member 134 is in its desired cross-car position, the tightening part 160 may then be tightened, which will close a gap defined between the moveable securing plate 154 and the stationary securing plate 156 thereby capturing or sandwiching the inwardly turned parts 166 of the opposing walls 164 of the slot 162 therebetween. Thereafter, the cross member 134 may be secured to the support foot 132 and restricted from moving. An end cap 170 (FIG. 6) may be attached to the open end 168 of the slot 162 to provide a closed look and to prevent dirt, dust, debris, and/or fluid from entering the inside of the cross member and/or the slot 162. The end cap 170 may also give the cross member 134 a clean, finished, closed look. An operator or user may tie or attach a rope, cord, cable, or strap to the handle part 118 and use the same to secure cargo in the bed or cargo area 12.

Referring back to FIG. 5, after the cross members 132 are attached to the support feet 134, a user may use the rack or platform system 130 to transport goods or objects. Because the cross members 134 are above the bed walls 16A, 16B, 18, 20, the tonneau cover 28 may still be moved between the open and closed positions without creating any obstructions.

As discussed above, the cargo securing system 100 according to these teachings provides a user or operator with the versatility of having an elevated rack or platform system 130 that can be quickly and easily attached and detached from the cargo area of the vehicle.

It should be understood that while the cross member is illustrated as extending across the cargo area (e.g., between opposing side walls 16A, 16B of the cargo area), a cross member 134 may instead be provided on only one side of the cargo area. For exampe, referring to FIG. 6A, the crossmember 134 may instead connect to the support feet 134A located at the front of the cargo area (i.e., near wall 18) and the other support foot 134A located near the tailgate 20. In such a configuration, either the handle portion 118 of the tie down 104 and the latch of the support foot may be arranged to be perpendicular to the longitudinal axis of the vehicle or cargo bed, or the one or more securing pars 152 of the support feet may be arranged or rotated to accommodate the cross member 134 in this configuration that extends along a same side of the bed wall.

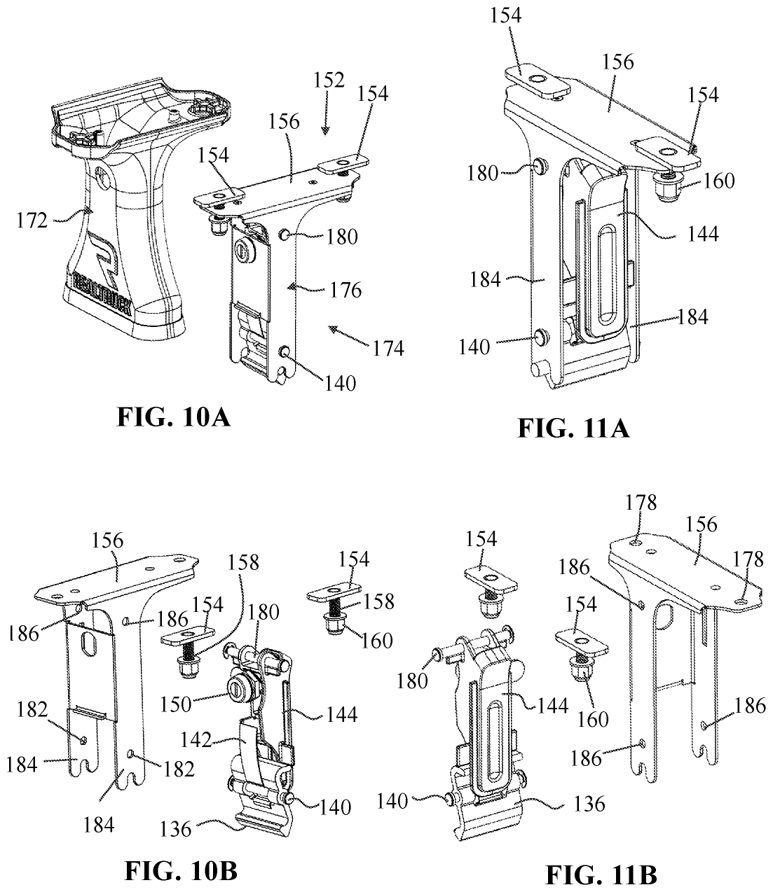

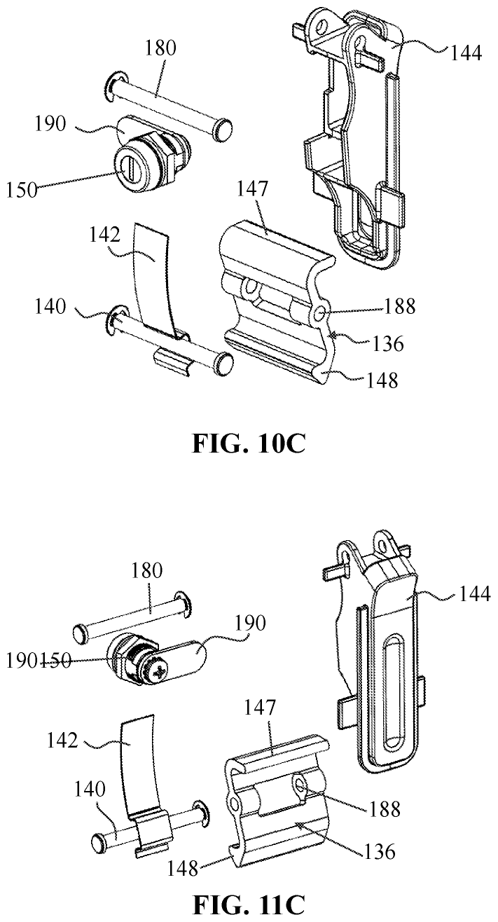

Referring to FIGS. 10A-11C, the support foot 132 includes an outer cover 172 and a mechanism 174 that is at least partially located within the outer cover 172. The mechanism 174 comprises a frame 176. The frame 176 comprises or is configured to support the stationary securing plate 156 and the securing parts 152 (the moveable securing plate 154, threaded part 158, tightening part 160). The frame 176 or stationary securing plate 156 comprises bores 178 for the threaded part 158 of the securing part 152 to engage. The bores 178 may or may not be threaded. The mechanism 174 may comprise a pivot axle 180 about which the button 144 of the latch 136 is configured to pivot about between the latched (FIG. 7A) and unlatched (FIG. 7B, 7C) positions. The axle 180 is received into or through a bore 182 that extends or is defined in each of the opposing legs 184 of the frame 176. The latch 136 comprises a finger 138. The finger 138 has an S- or Z-shape and is configured to rotate or pivot about pin or axle 140. The pin or axle 140 is received into/through bores 186 defined in each of the legs 184 of the frame 176. The finger 138 includes a central bore 188 through the pin or axle 140 extends. The finger 138 comprises an upper part 147 and an opposing lower part 148 or leading end 148. The button 144 is moved into contact with the upper part 147 of the finger 138 to move or rotate the finger 138 about the axle 140 and move the spring or bias member 142 from the latched position (FIG. 7A) to the unlatched position (FIG. 7B, 7C). The lower part 148 of the finger 138 is configured to engage the handle 118 of the tie down 104 to attach the support foot 132 to the tie down 104. The lock 150 may include a tumbler or latch 190 that can be rotated by a key to lock the button 144 and/or the finger 138 to prevent the finger 138 from rotating into the unlatched position. The spring or bias member 142 may be an elongated strip of material The spring or bias member 142 may be a resilient material, such as a metal. The spring or bias member 142 may be curved or vent around the pin or axle 140 about which the finger 136 is configured to rotate or pivot. One end of the spring or bias member 142 may contact or press against the button 144 to move the button 144 into its steady state position after the button is no longer depressed by the user.

Referring to the previous figures, the cargo securing system 100 comprises two securing rails 102A, 102B. A first rail 102A of the two securing rails is attached to the first wall 16A of the cargo area 12, and a second rail 102B of the two securing rails is attached to the second wall 16B of the cargo area 12. The cargo securing system 100 comprises two tie downs 104, 104. A first tie down 104A is attached to the first rail 102A, and a second tie down 104B is attached to the second rail 102B. The cargo securing system 100 comprises two support feet 132A, 132B. A first support foot 132A is attached to the first tie down 104A, and a second support foot 132B is attached to the second tie down 104B. The cargo securing system 100 comprises a cross member 134 to connect to the two support feet 132A, 132B and extend across the cargo area 12. The first support foot 132A comprises a latch 136 that is configured to engage the first tie down 104A to attach the first support foot 132A to the first tie down 104A.

The first tie down 104A a base 114, two upright portions 116, and a handle 118 extending between the two upright portions 116, the latch 136 comprises a finger 138 that engages the handle 118. The first tie down 104 comprises a gap G defined between the handle 118 and the base 114. The first tie down 104A comprises a securing part 120 that is configured to engage an engagement slot 110 in the first rail 102A. The securing part 120 comprises a moveable securing plate 122 that is configured to be moved to sandwich a region 112, 113 of the engagement slot 110 between the moveable securing plate 122 and the base 114 of the first tie down 104A. The finger 138 is configured to pivot or rotate about an axle 140 to move the finger 138 between a latched position and an unlatched position, wherein in the latched position, the finger 138 engages the handle 118 of the first tie down 104A. The latch 136 comprises a button 144 and movement or depression of the button 144 causes the finger 138 to move into the unlatched position where the finger 138 disengages the handle 118 of the first tie down 104A. The latch 136 comprises a spring or bias member 142 that is configured to move the finger 138 into the latched position after the button is released. The first support foot 132A comprises a lock 150 for locking a position of the finger 138. The first support foot 132A has an L- or T-shape. The first support foot 132A has a securing part 152 configured to engage an engagement slot 162 in the cross member 134. The securing part 152 of the first support foot 132A comprises a stationary securing plate 156 and a moveable securing plate 154 that is configured to be moved relative to the stationary securing plate 154 to sandwich a region 164, 166 of the engagement slot 162 of the cross member 134 between the moveable securing plate 154 and the stationary securing plate 156. The engagement slot 162 comprises a pair of opposing walls 164 and a pair of inwardly turned fingers 166 to define a cross section having a C- or U-shape. The cross member 134 when installed between the two support feet is free from interfering with operation of a tonneau cover (i.e., allows the tonneau cover to move between the open and closed configuration or position without interfering with movement of the cover). The finger 138 of the latch 126 is configured to engage the handle 118 of the first tie down 104A without use of hand tools or tightening any fasteners.

It is understood that the following method steps can be performed in virtually any order. Moreover, one or more of the following method steps can be combined with other steps; can be omitted or eliminated; can be repeated; and/or can separated into individual or additional steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps. For example, disclosure of “a latch” does not limit the teachings to a single latch. Instead, for example, disclosure of “a latch” may include “one or more laches.”

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The invention illustratively disclosed herein suitably may be practiced in the absence of any element which is not specifically disclosed herein.

Any of the elements, components, regions, layers and/or sections disclosed herein are not necessarily limited to a single embodiment. Instead, any of the elements, components, regions, layers and/or sections disclosed herein may be substituted, combined, and/or modified with any of the elements, components, regions, layers and/or sections disclosed herein to form one or more embodiments that may be not be specifically illustrated or described herein.

The disclosures of all articles and references, including patent applications and publications, testing specifications, are incorporated by reference for all purposes. Other combinations are also possible as will be gleaned from the following claims, which are also hereby incorporated by reference into this written description.

### LISTING OF REFERENCE NUMERALS

12 bed or cargo area
14 passenger area or cab
16 side walls of the cargo area
18 front wall of the cargo area
20 tailgate
22 bottom or floor of cargo area
24 tonneau cover system
26 side rails
28 tonneau cover
100 cargo securing system
102 securing rail
104 tie down
106 horizontal portion of side rail 102
108 vertical portion of side rail 102
110 engagement slot of side rail 102
112 walls that define the engagement slot 110 of the side rail 102
113 inwardly turned fingers from the walls 112
114 base of the tie down 104
116 upright portion of body 114
118 handle part of the body 114
120 securing part
122 moveable securing plate
124 threaded part
126 tightening part
128 open end of the slot 110
130 rack or platform system
132 support feet
134 cross member
136 latch
138 finger of latch 136
140 pin or axle of latch 136
142 spring or bias member of latch 136
144 button of latch 136
146 rib on button 144
147 upper part of finger 138
148 lower part of finger 138/leading end or surface of finger 138
150 lock
152 securing part of the support foot 132
154 moveable securing plate of securing part 152
156 stationary securing plate of securing part 152
158 threaded part of securing part 152
160 tightening part of securing part 152
162 engagement slot of cross member 134
164 walls of engagement slot 162
166 fingers of engagement slot 162
168 open end of the engagement slot 162 of the cross member 134
170 end cap
172 outer cover
174 mechanism
176 frame of mechanism 174
178 bores that the threaded parts 158 engage
180 axle that the button 144 pivots about
182 bores that the axle 180 extends
184 opposing legs of frame 176
186 bore for pin or axle 140 in each of the legs 184 of frame 176
188 central bore 188 in finger 138 for axle 140 to extend
190 arm or tumbler of the lock 150

1. A cargo securing system for a vehicle having a cargo area, the cargo area having a first wall and an opposing second wall, the cargo securing system comprises:
two tie downs, wherein a first tie down of the two tie downs is attached to the first rail, and a second tie down of the two tie downs is attached to the second rail;
two support feet, wherein a first support foot of the two support feet is attached to the first tie down, and a second support foot of the two support feet is attached to the second tie down; and
a cross member configured to connect to the two support feet and extend across the cargo area;
wherein the first support foot comprises a latch that is configured to engage the first tie down to attach the first support foot to the first tie down.

2. The cargo securing system according to claim 1, wherein the first tie down comprises a base, two upright portions, and a handle extending between the two upright portions, wherein the latch comprises a finger that engages the handle.

3. The cargo securing system according to claim 1, wherein the cargo securing system comprises two securing rails, wherein a first rail of the two securing rails is attached to the first wall of the cargo area, and a second rail of the two securing rails is attached to the second wall of the cargo area, wherein the first tie down is attached to the first rail and the second tie down is attached to the second rail.

4. The cargo securing system according to claim 3, wherein the first tie down comprises a securing part that is configured to engage an engagement slot in the first rail.

5. The cargo securing system according to claim 4, wherein the securing part comprises a moveable securing plate that is configured to be moved to sandwich a region of the engagement slot between the moveable securing plate and the base of the first tie down.

6. The cargo securing system according to claim 2, wherein the finger is configured to pivot or rotate about an axle to move the finger between a latched position and an unlatched position, wherein in the latched position, the finger engages the handle of the first tie down.

7. The cargo securing system according to claim 6, wherein the latch comprises a button and movement of the button causes the finger to move into the unlatched position where the finger disengages the handle of the first tie down.

8. The cargo securing system according to claim 7, wherein the latch comprises a spring or bias member, the spring or bias member is configured to move the finger into the latched position after the button is released.

9. The cargo securing system according to claim 8, wherein the first support foot comprises a lock for locking a position of the finger.

10. The cargo securing system according to claim 9, wherein the first support foot has an L- or T-shape.

11. The cargo securing system according to claim 1, wherein the first support foot comprises a securing part configured to engage an engagement slot in the cross member.

12. The cargo securing system according to claim 11, wherein the securing part of the first support foot comprises a stationary securing plate and a moveable securing plate that is configured to be moved relative to the stationary securing plate to sandwich a region of the engagement slot of the cross member between the moveable securing plate and the stationary securing plate.

13. The cargo securing system according to claim 11, wherein the cross member comprises the engagement slot and a second engagement slot.

14. The cargo securing system according to claim 11, wherein the engagement slot and/or the second engagement slot comprises a pair of opposing walls and a pair of inwardly turned fingers to define a cross section having a C- or U-shape.

15. A cargo securing system for a vehicle having a cargo area, the cargo area having a first wall and an opposing second wall, the cargo securing system comprises:
two securing rails, wherein a first rail of the two securing rails is attached to the first wall of the cargo area, and a second rail of the two securing rails is attached to the second wall of the cargo area;
two tie downs, wherein a first tie down of the two tie downs is attached to the first rail, and a second tie down of the two tie downs is attached to the second rail, the first tie down comprises a base, two upright portions, and a handle extending between the two upright portions;
two support feet, wherein a first support foot of the two support feet is attached to the first tie down, and a second support foot of the two support feet is attached to the second tie down; the first support foot comprises a latch, the latch comprises a finger that pivots or rotates about an axle to move the finger between a latched position and an unlatched position, wherein in the latched position, the finger engages the handle of the first tie down; and
a cross member configured to connect to the two support feet and extend across the cargo area.

16. The cargo securing system according to claim 15, wherein the latch comprises a button, and movement of the button causes the finger to move into the unlatched position where the finger disengages the handle of the first tie down, and the latch comprises a spring or bias member, the spring or bias member is configured to move the finger into the latched position after the button is released.

17. A cargo securing system for a vehicle having a cargo area, the cargo area having a first wall and an opposing second wall, the cargo securing system comprises:
a tie down attached to a side wall of a vehicle, the tie down comprises a base, two upright portions, and a handle extending between the two upright portions; and
a support foot, the support foot comprises a latch, the latch comprises a finger that pivots or rotates about an axle to move the finger between a latched position and an unlatched position, wherein in the latched position, the finger engages the handle of the tie down.

18. The cargo securing system according to claim 17, wherein the cargo securing system comprises a cross member, the cross member is configured to connect to the support foot, wherein the cross member extends along a length of the first wall or the second wall, or the cross member extends between the first wall and the second wall.

19. The cargo securing system according to claim 17, wherein the support foot comprises a button, and movement of the button causes the finger to move into the unlatched position where the finger disengages the handle of the tie down to separate or remove the support foot from the tie down.

20. The cargo securing system according to claim 17, wherein the latch comprises a spring or bias member, the spring or bias member is configured to move the finger into the latched position in a steady state configuration.
